(19) United States
(12) Patent Application Publication
(10) Pub. No.: US 2015/0134704 A1
(43) Pub. Date: May 14, 2015

(54) Real Time Analysis of Big Data

(71) Applicant: International Business Machines Corporation, Armonk, NY (US)

(72) Inventor: Robert J. Wallis, Cheshire (GB)

(21) Appl. No.: 14/518,322

(22) Filed: Oct. 20, 2014

(30) Foreign Application Priority Data
Nov. 8, 2013 (GB) 1319706.6

(51) Int. Cl. G06F 17/30

(52) U.S. Cl. CPC G06F 17/30091; G06F 17/30592; G06F 17/30386
USPC 707/803

(57) ABSTRACT

This invention relates to a system, method and computer program product for processing large scale unstructured data comprising: a receiver for receiving streamed input data from live data sources; a pattern generator for deriving emergent patterns in data subsets; a pattern identifier for identifying a repeating pattern and corresponding data subset within the emergent patterns; a compressor for reducing the identified data subset and identified pattern to a compressed signature; and a repository for storing the streamed input data with the compressed signature and without the identified data subset wherein the data subset can be rebuilt if necessary using the compressed signature.

### FIELD OF THE INVENTION

This invention relates to a method and apparatus for real time analysis of large sets of unstructured data.

### BACKGROUND

Deep analytics is an emerging growth application of computing technology. The principle driving force of this is that a very large quantity of data, often unstructured (also known as deep data), is collected using every method possible. At a later point, this data can be analyzed to produce business insight based on prior data.

Examples of deep analytics would be a mobile phone retailer documenting the following:
a. the length of time a customer spends in the shop and the time of day that this has occurred;
b. the date and time of each phone sale and the type of the phone that was sold;
c. the length of time spent in the shop and the type of phone purchased;
d. the title, artist and type of music being played in the store at any given time;
e. the names of staff who sold phones and the times that these were sold; and
f. feedback questionnaires from customers some with time and date associated with them.

The retailer can then run a complex deep analytics style query to see whether the music playing in the shop affected the sales patterns of their salespeople in different ways. For example, they can have a longer sales time, but higher phone purchase price for 40% of their staff while Mozart is playing. This data can then be used to re-arrange the shift pattern of workers to make the similarly motivated staff work together with the most motivating music, thus achieving higher margin sales as a result.

The following patent publications describe systems that adopt the deep analytics approach described above.

US patent publication 7930260 B2 discloses a system and method for real time patter identification.

US patent publication 2013/0144813 A1 discloses analyzing data sets with the help of inexpert humans to find patterns.

WO patent publication 2005/116887 A1 discloses a data analysis and flow control system.

WO patent publication 2006/076111 discloses identifying data patterns.

One main drawback with the above approaches is that it is not known which data will be relevant so that all data is collected in the hope that some of it will be relevant at some point. Such approaches are expensive and inefficient but often taken for granted as a necessary side effect of using a big data, deep insight, approach.

### BRIEF SUMMARY OF THE INVENTION

In a first aspect of the invention there is provided a system for processing large scale unstructured data comprising: a receiver for receiving streamed input data from live data sources; a pattern generator for deriving emergent patterns in data subsets; a pattern identifier for identifying a repeating pattern and corresponding data subset within the emergent patterns; a compressor for reducing the identified data subset and identified pattern to a compressed signature; and a repository for storing the streamed input data with the compressed signature and without the identified data subset wherein the data subset can be rebuilt if necessary using the compressed signature.

In a second aspect of the invention there is provided a method for processing large scale unstructured data comprising: receiving streamed input data from live data sources; deriving emergent patterns in data subsets; identifying a repeating pattern and corresponding data subset within the emergent patterns; reducing the identified data subset and identified pattern to a compressed signature; and storing the streamed input data with the compressed signature and without the identified data subset wherein the data subset can be rebuilt if necessary using the compressed signature.

As data is being collected by the big data warehouse it is analyzed in real time (also known as real time analytics) to identify emerging patterns and where a regular pattern is seen, the data can be compressed and only anomalous data stored.

An important corollary to the compression is that any data that does not fit the regular pattern cannot be compressed. This data is kept as a unique instance and can be independently flagged as ‘irregular’ or novel. This irregular data is likely to be of interest to deep analytics algorithms at a later date.

Advantageously, the method further comprises a periodic limit and, within the data subset, identifying and not compressing outlier data that may or may not repeat outside the periodic limit.

More advantageously, the method further comprising identifying two or more patterns that repeat with the periodic limit in the same data subset and compressing said two or more patterns into the same compression signature.

Still more advantageously, the compressed signature comprises any compressed representation or generalized equation of the data subset.

Preferably, said method further comprising identifying and flagging from the emergent patterns: new patterns; feature-rich patterns; and/or non-significant correlations. Where irregular, novel or interesting patterns are seen these are flagged for later deep analysis. This can be exposed via marked data sets to deep analytics software to enable more targeted deep analytics operations at a later date. This is a beneficial side effect of performing the real time analytics based compression during data collection. For example, it would be advantageous to indicate that certain data subsets have been reduced to a random function so that further deep analysis can avoid process it and save time.

More preferably, wherein an emergent pattern is derived by applying real-time analytics techniques.

When the real time analytics assesses the patterns in the data set, it can choose one of three actions.
a. Compress the whole data set and model it completely using a modelling algorithm (for example, normal distribution, random data). This would be the case if the pattern repeated with the periodic limit
b. Compress the majority of the data as above, and keep the data which does not fit with the model. This anomalous data can then be flagged as interesting, novel or irregular. Hints can be given through means of flags for deep analytics software to pay special attention to this data during deep analysis at a later point. This is the case if some of the patterns repeat outside the periodic limit.
c. Keep the whole data set and mark it as a point of special interest. Action can then be taken to run a finer grained real time analysis (by reducing the size of the data set) or preserving the complete set for deep analysis at a later date. This is the case if all the patterns repeat outside the periodic limit

The embodiments have a liberating effect on a data mining process carried on outside the computer because the volume of data stored is reduced and the data mining system has less processing to do. The embodiments operate at a system level of a computer and below an overlying application level.

In a third aspect of the invention there is provided a computer program product for processing large scale unstructured data, the computer program product comprising a computer-readable storage medium having computer-readable program code embodied therewith and the computer-readable program code configured to perform all the steps of the methods.

The computer program product comprises a series of computer-readable instructions either fixed on a tangible medium, such as a computer readable medium, for example, optical disk, magnetic disk, solid-state drive or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In a fourth aspect of the invention there is provided a computer program stored on a computer readable medium and loadable into the internal memory of a digital computer, comprising software code portions, when said program is run on a computer, for performing all the steps of the method claims.

In a fifth aspect of the invention there is provided a data carrier aspect of the preferred embodiment that comprises functional computer data structures to, when loaded into a computer system and operated upon thereby, enable said computer system to perform all the steps of the method claims. A suitable data-carrier could be a solid-state memory, magnetic drive or optical disk. Channels for the transmission of data may likewise comprise storage media of all descriptions as well as signal-carrying media, such as wired or wireless signal-carrying media.

### BRIEF DESCRIPTION OF THE DRAWINGS

Preferred embodiments of the present invention will now be described, by way of example only, with reference to the following drawings in which:

FIG. 1 is a deployment diagram of the preferred embodiment;

FIG. 2 is a component diagram of the preferred embodiment;

FIG. 3 is a flow diagram of a process of the preferred embodiment; and

FIGS. 4A to 4C are examples showing how the data size can be reduced.

### DETAILED DESCRIPTION OF THE EMBODIMENTS

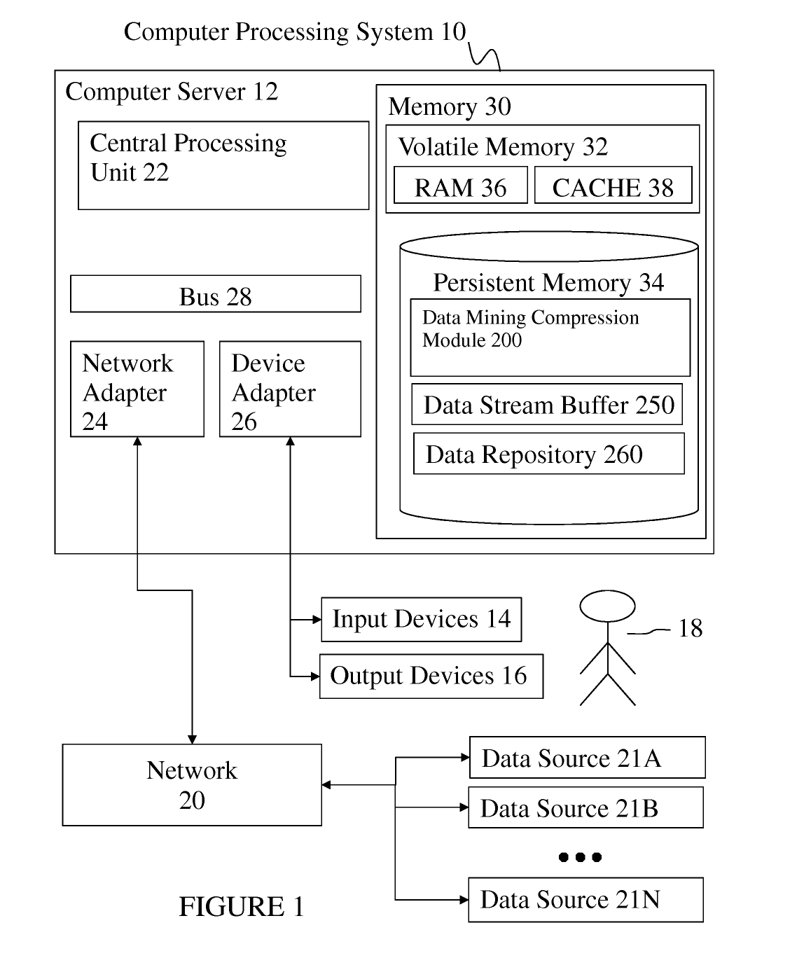

Referring to FIG. 1, the deployment of a preferred embodiment in computer processing system 10 is described. Computer processing system 10 is operational with numerous other general purpose or special purpose computing system environments or configurations. Examples of well-known computing processing systems, environments, and/or configurations that may be suitable for use with computer processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer processing system 10 may be described in the general context of computer system-executable instructions, such as program modules, being executed by a computer processor. Generally, program modules may include routines, programs, objects, components, logic, and data structures that perform particular tasks or implement particular abstract data types. Computer processing system 10 may be embodied in distributed cloud computing environments where tasks are performed by remote processing devices that are linked through a communications network. In a distributed cloud computing environment, program modules may be located in both local and remote computer system storage media including memory storage devices.

Computer processing system 10 comprises: general-purpose computer server 12 and one or more input devices 14 and output devices 16 directly attached to the computer server 12. Computer processing system 10 is connected to a network 20. Computer processing system 10 communicates with a user 18 using input devices 14 and output devices 16. Input devices 14 include one or more of: a keyboard, a scanner, a mouse, trackball or another pointing device. Output devices 16 include one or more of a display or a printer. Computer processing system 10 communicates with network devices (not shown) over network 20. Network 20 can be a local area network (LAN), a wide area network (WAN), or the Internet.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations include: incrementing or decrementing a value in register (not shown); transferring a value from memory 30 to a register or vice versa; branching to a different location in memory if a condition is true or false (also known as a conditional branch instruction); and adding or subtracting the values in two different registers and loading the result in another register. A typical CPU can perform many different machine operations. A set of machine instructions is called a machine code program, the machine instructions are written in a machine code language which is referred to a low level language. A computer program written in a high level language needs to be compiled to a machine code program before it can be run. Alternatively a machine code program such as a virtual machine or an interpreter can interpret a high level language in terms of machine operations.

Network adapter 24 is connected to bus 28 and network 20 for enabling communication between the computer server 12 and network devices.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Generally volatile memory is used because it is faster and generally non-volatile memory is used because it will hold the data for longer. Computer processing system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The set of program modules configured to carry out the functions of the preferred embodiment comprises: data mining compression module 200; data stream buffer 250; and data repository 260. Further program modules that support the preferred embodiment but are not shown include firmware, boot strap program, operating system, and support applications. Each of the operating system, support applications, other program modules, and program data or some combination thereof, may include an implementation of a networking environment.

Computer processing system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with computer processing system 10. Examples, include, but are not limited to: microcode, device drivers, redundant processing units, external disk drive arrays, redundant array of independent disks (RAID), tape drives, and data archival storage systems.

Data mining compression module 200 is for performing compression on data held in the data stream buffer 250 and provides output to data repository 260 and is described in more detail below.

Data stream buffer 250 is for receiving data from data sources 21A to 21N and is operated on by data mining compression module 200.

Data repository 260 is for storing the data and compressed data from data mining compression module.

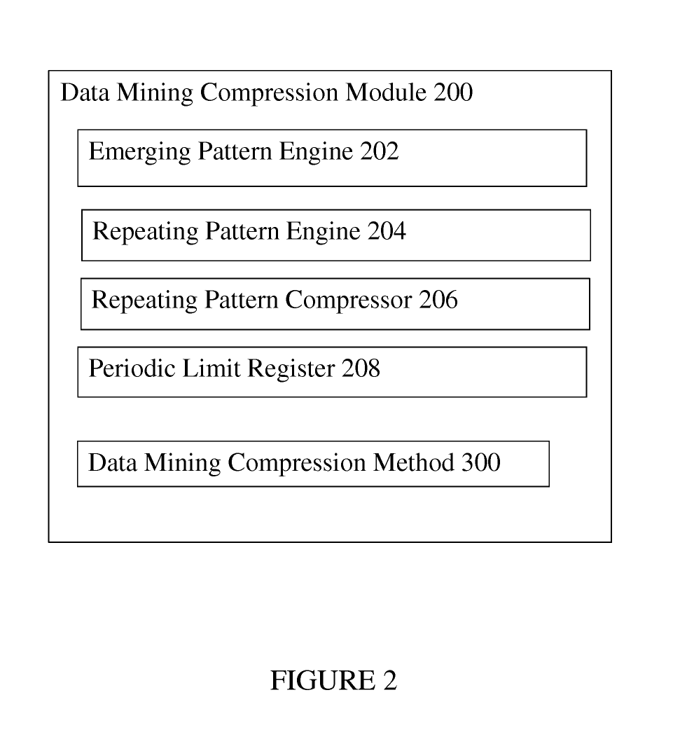

Referring to FIG. 2, data mining compression module 200 comprises the following components: emerging pattern engine 202; repeating pattern engine 204; repeating pattern compressor 206; periodic limit register 208; and data mining compression method 300.

Emerging pattern engine 202 is for identifying emerging patterns in the data sources.

Repeating pattern engine 204 is for identifying repeating patterns in the emerging patterns. Repeating patterns have to repeat within a certain predefined periodic limit, if they repeat outside of the periodic limit then the data is identified as special but not as repeating patterns for the purposes of compression.

Repeating pattern compressor 206 is for compressing identified repeating patterns.

Periodic limit register 208 is for storing the periodic limit used for identifying the repeating pattern

Data mining compression method 300 controls the components of data mining compression module 200 and is described in more detail below.

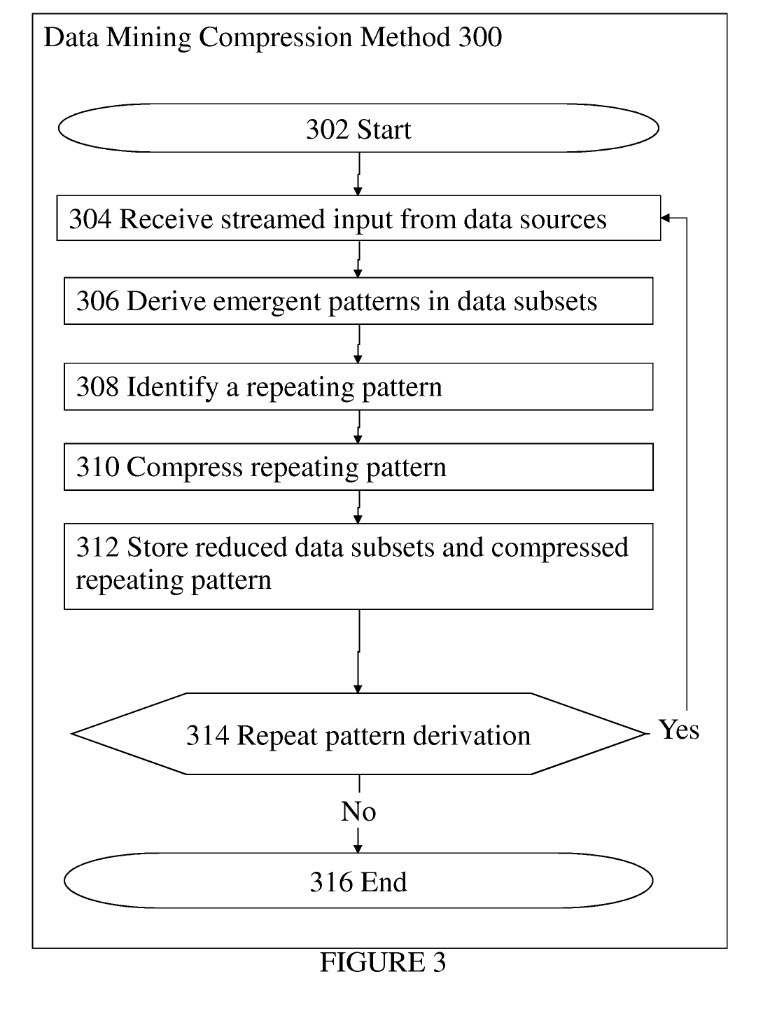

Referring to FIG. 3, data mining compression method 300 comprises logical process steps 302 to 316.

Step 302 is the start of the method.

Step 304 is for receiving streamed input from data sources 21A to 21N before or after they are stored in data stream buffer 250.

Step 306 is for deriving emergent patterns in the data subsets. Emerging pattern engine 202 is called.

Step 308 is for identifying a repeating pattern. Repeating pattern engine 204 is called.

Step 310 is for compressing any identified repeating patterns such that the data subset data volume is reduced. Repeating pattern compressor 206 is called.

Step 312 is for storing the reduced data subset and compressed repeating pattern.

Step 314 is for deciding to repeat pattern derivation and if so for continuing at step 304. Else step 316.

Step 316 is the end of data mining compression method 300.

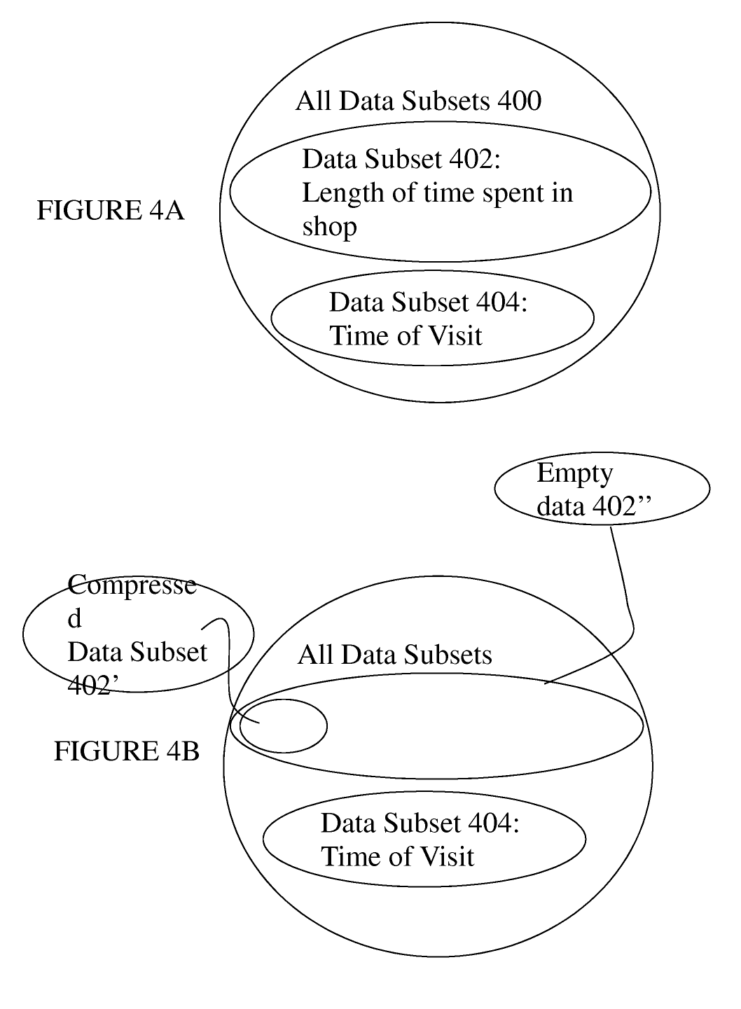

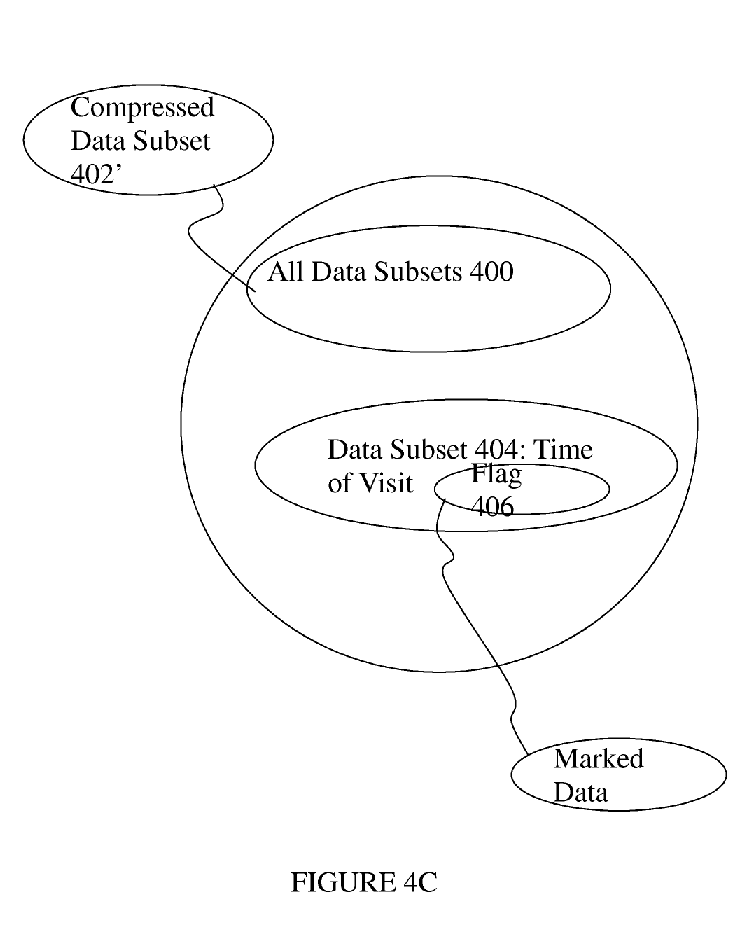

Referring to FIG. 4A to 4C, examples of the preferred embodiment are described.

Referring to FIG. 4A, a first set of data will be examined including the length of time a customer spends in the shop with the time of day this has occurred and other data, all represented by all data subsets 400. After a period of observation (or training) by the real time analytics engine (for example, one weeks worth of data), the length of time spent in the shop (data subset 402) can be seen to be completely independent to the time of day of that visit (data subset 404). Working from the observation that historic data points can then be discarded and replaced with a random behavior model with the correct parameters to recreate an accurate representation of the data that had been collected.

Referring to FIG. 4B, this means that the previous weeks data (empty data 402″) can be discarded, and an equation (compressed data subset 402′) can be stored instead. When deep insight algorithms are being executed at a later point, the data can be re-generated on demand to enable the deep insight to use the data in whatever algorithm it needs to.

Referring to FIG. 4C, data subset 404 has been marked with flag 406 because the data subset is deemed of interest for later analysis. For example, it would be advantageous to indicate that subset 402′ and/or 404 have been reduced to random functions so that further deep analysis can avoid processing and save time.

Further embodiments of the invention are now described. It will be clear to one of ordinary skill in the art that all or part of the logical process steps of the preferred embodiment may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of the preferred embodiment may be alternatively embodied in logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of the preferred embodiment may alternatively be embodied fully or partially in a parallel computing system comprising two or more processors for executing parallel software.

It will be clear to one skilled in the art that many improvements and modifications can be made to the foregoing exemplary embodiment without departing from the scope of the present invention.

1. A system for processing large scale unstructured data comprising:
a receiver for receiving streamed input data from live data sources;
an emerging pattern engine for deriving emergent patterns in data subsets;
a repeating pattern engine for identifying a repeating pattern and corresponding data subset within the emergent patterns;
a compressor for reducing the identified data subset and identified pattern to a compressed signature; and
a repository for storing the streamed input data with the compressed signature and without the identified data subset wherein the data subset can be rebuilt if necessary using the compressed signature.

2. A system as in claim 1 further comprising a periodic limit and, within the data subset, identifying and not compressing outlier data that may or may not repeat outside the periodic limit

3. A system as claimed in claim 2 further comprising identifying two or more patterns that repeat with the periodic limit in the same data subset and compressing said two or more patterns into the same compression signature.

4. A system as in claim 1 wherein the compressed signature comprises any compressed representation or generalized equation of the data subset.

5. A system as in claim 1 further comprising identifying and flagging from the emergent patterns: new patterns; feature-rich patterns; and/or non-significant correlations.

6. A system as in claim 1 wherein an emergent pattern is derived by applying real-time analytics techniques.

7. A method for processing large scale unstructured data comprising:
receiving streamed input data from live data sources;
deriving emergent patterns in data subsets;
identifying a repeating pattern and corresponding data subset within the emergent patterns;
reducing the identified data subset and identified pattern to a compressed signature; and
storing the streamed input data with the compressed signature and without the identified data subset wherein the data subset can be rebuilt if necessary using the compressed signature.

8. A method as claimed in claim 7 further comprising a periodic limit and, within the data subset, identifying and not compressing outlier data that may or may not repeat outside the periodic limit

9. A method as claimed in claim 8 further comprising identifying two or more patterns that repeat with the periodic limit in the same data subset and compressing said two or more patterns into the same compression signature.

10. A method as claimed in claim 7 wherein the compressed signature comprises any compressed representation or generalized equation of the data subset.

11. A method as claimed in claim 7 further comprising identifying and flagging from the emergent patterns: new patterns; feature-rich patterns; and/or non-significant correlations.

12. A method as claimed in claim 7 wherein an emergent pattern is derived by applying real-time analytics techniques.

13. A computer program product for processing large scale unstructured data, the computer program product comprising a computer-readable storage medium having computer-readable program code embodied therewith, the computer-readable program code configured to perform claim 7.

14. A computer program stored on a computer readable medium and loadable into the internal memory of a digital computer, comprising software code portions, when said program is run on a computer, for performing claim 7.
